(19) United States
(12) Patent Application Publication
(10) Pub. No.: US 2006/0209550 A1
(43) Pub. Date: Sep. 21, 2006

(54) Fixture for a door

(76) Inventor: Solange B. Fabiao, New York, NY (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/083,458

(22) Filed: Mar. 18, 2005

(51) Int. Cl. B60Q 1/26

(52) U.S. Cl. 362/501

(57) ABSTRACT

A fixture for a door or compartment comprises a grip on a rigid support. The fixture may be incorporated into a standard door latch assembly. The grip may be tactile or rigid, transparent or translucent, or opaque. It may comprise of one or more perforations therein, and molded in plain metal or a variety of colors, with or without a complimentary internal light source. Alternatively, a fixture for a door or compartment comprises a transparent or translucent rigid material or a pliant polymer, which is provided with at least one internal light source that can be set for different colors. The light sources may be lit alternately or simultaneously to convey information about a room connected to a doorway or to elicit a particular behavior from an individual.

### FIELD OF THE INVENTION

The present invention is related to the field of hardware for a door, a drawer or other fixture that is gripped by a user for the purpose of opening.

### BACKGROUND

Over the years there have been a number of aesthetic variations on hardware to be used in conjunction with doorways, drawers and cabinets. Most of these variations have dealt with unique shapes or designs for doorknobs, handles or levers. Very little has been done to vary the appearance of these fixtures beyond their general shape, and even less regarding the other aesthetic and sensorial aspects of these fixtures.

A number of inventors have also attempted to improve the functionality of doorway and cabinetry fixtures by incorporating lighting elements into the fixtures. U.S. Pat. No. 941,576 to Hardin et al., U.S. Pat. No. 2,438,847 to Dreese, U.S. Pat. No. 5,398,175 to Pea and U.S. Pat. No. 4,777,570 to Little disclose doorknobs and handles with illuminated door locks. U.S. Pat. No. 1,263,880 to Glossop and 6,729,740 to Gazard disclose illuminated doorknobs to aid in locating a door in a darkened room. However, none of these patents address the aesthetic appearance or other aesthetic or sensorial qualities of the door fixture. Further, none of these patents discloses any functionality other than illuminating a door lock or the doorknob or handle itself.

U.S. Pat. No. 4,683,741 to Fields discloses a door latch assembly having an incorporated light to indicate when the door is locked. The assembly disclosed in U.S. Pat. No. 4,683,741 has the light mechanism outside of the doorknob, and only includes a light that is capable of being on or off.

Therefore, it would be useful to provide a new type of fixture for a doorway, cabinet, drawer or other compartment that includes the aesthetic, sensorial and functional features not heretofore addressed in the art. Such a new fixture would address aesthetic features other than the shape of the knob, handle or lever incorporated into the fixture. It would also address other sensory perceptions of the fixture. Further, the new fixture would make use of light to provide various information about a room connected to a doorway.

### SUMMARY OF THE INVENTION

In one embodiment the present invention is tactile fixture for a compartment or door, comprising either a knob, handle or lever. The knob, handle or lever comprises a rigid support substantially covered by a pliant polymer, which is deformable, such that when a user grips the knob, handle or lever, the pliant polymer deforms in response to the grip. When the grip is released the polymer relaxes substantially to its original shape. The tactile fixture of the present invention may be incorporated into a door for a doorway, a cabinet or a drawer for example.

In another embodiment, the present invention provides a fixture for a doorway comprising a grip in the shape of a knob, handle or lever with at least one light source disposed within. The grip is capable of transmitting light from the at least one light source incorporated therein, such that the fixture can be illuminated in a selected color. To achieve this the grip may comprise a rigid shell having a plurality of perforations therein for transmitting light. Alternatively, the grip may comprise a rigid transparent or translucent material, which may be glass or a polymer. Further, the grip may comprise a pliant translucent or transparent polymer disposed on a rigid support, such as a spine. The light source(s) may be of any type, preferably light emitting diodes. In a preferred embodiment the fixture contains a programmable light emitting diode capable of emitting at least two different colors, which are emitted alternately and thereby provide information about a room or compartment connected to a doorway. In another preferred embodiment, two or more lights of different colors may light alternately or simultaneously to convey other information to an individual, such as welcome, or to induce a specific behavior, such as silence. In a particularly preferred embodiment, three light sources of different colors may be disposed within the grip, which when lighted in different combinations and intensities produce multiple colors. For example, a red, green and blue light may be incorporated into the current invention, making the fixture capable of producing all colors in the spectrum.

The current invention also provides a method of conveying information about the status of a room. The method comprises providing a door having a fixture thereon. The fixture comprises a grip in the shape of a knob, handle or lever. The grip is capable of transmitting light from at least one programmable light source incorporated therein, such that said fixture can be illuminated in at least two colors alternately. To achieve this the grip may comprise an opaque material having a plurality of perforations therein for transmitting light. Alternatively, the grip may comprise a transparent or translucent material, which may be glass or a polymer. The light source is programmed so that the illuminated color of the fixture changes in response to the status of a room connected to the door.

### BRIEF DESCRIPTION OF THE DRAWINGS

FIG. 1: Illustrates a doorknob according to an exemplary embodiment of the invention.

FIG. 2: Illustrates a doorknob according to an exemplary embodiment of the invention.

FIG. 3: Illustrates a lever according to an exemplary embodiment of the invention.

FIG. 4: Illustrates a lever incorporating a light source according to the current invention.

FIG. 5: Illustrates an alternate view of a lever incorporating a light source according to the current invention.

FIG. 6: Illustrates a doorknob according to the current invention incorporating a light source.

FIG. 7: Illustrates a doorknob according to the current invention incorporating a light source.

FIG. 8: Illustrates a lever incorporating a light source according to the current invention.

### DETAILED DESCRIPTION OF THE INVENTION

The present invention is a fixture for a door or a compartment. The fixture is in the shape of a knob, lever or handle. In alternate embodiments of the invention, the inventive fixture provides an improvement on the aesthetic and sensorial qualities of fixtures currently available, and/or performs a purely functional purpose of providing information regarding the status of a room or compartment. The present invention also provides a method for conveying information about the status of a room or compartment.

In one embodiment of the current invention, a tactile fixture comprises a rigid support with a pliant polymer grip. By a pliant polymer as used herein is meant a polymer which yields and deforms when gripped by an individual, but relaxes substantially to its original shape when the grip is released. The tactile quality of the fixture imparts an improved aesthetic quality, which is more pleasing to a user than the cold hard feel of traditional door fixtures. The pliant polymer may be molded over the rigid support, or it may be produced separately so that various shapes and colors of cover can be interchanged on the same support.

In a preferred embodiment the tactile polymer is a polyurethane. In a more preferred embodiment, the polyurethane is a polyether/polyol, available from Bayer under the trade name Levagel®.

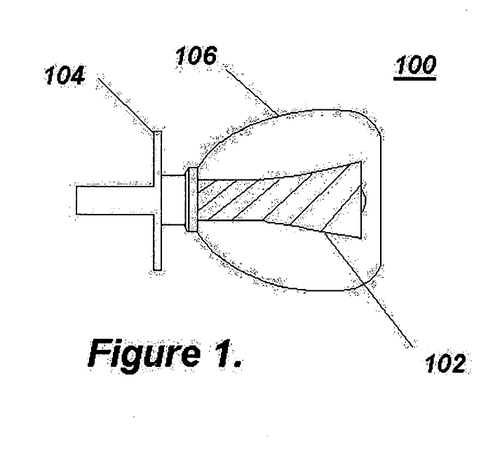

Referring to FIG. 1, an exemplary embodiment of a doorknob according to this embodiment is shown. The knob 100 comprises rigid support 102, which is incorporated into a door latch assembly 104, which is a standard mechanism, such as that described in U.S. Pat. Nos. 4,777,570 or 4,683,741. A grip comprising a tactile polymer 106 forming the knob to be gripped by a user is molded over the rigid support 102.

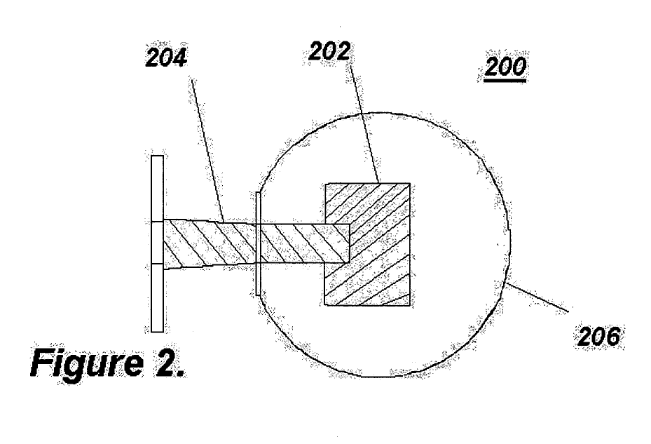

Referring to FIG. 2, an alternative embodiment of a doorknob 200 according to the invention is shown wherein the rigid support 202 comprises a square block with a shaft 204 with a grip 206 formed from a tactile polymer molded over the support.

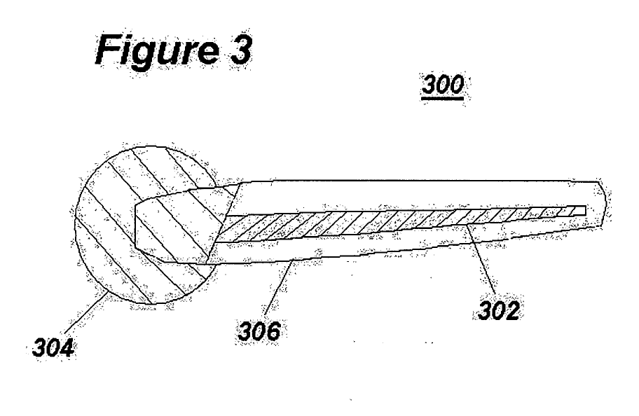

Referring now to FIG. 3, another alternative embodiment of the invention is illustrated. According to this embodiment, a lever 300 comprises a rigid support 302, which is incorporated into a door latch assembly 304. Again the rigid support is substantially covered by a grip comprising a pliant polymer.

The rigid support may be made of any rigid durable material, such as metal, wood, polymer or other composite material.

By substantially covered as used herein is meant that at least a major portion of the rigid support is covered by the polymer. It is preferred that the entire support be covered by the polymer. However, in some embodiments, a portion of the support may be exposed.

The knob or grip may be molded in a variety of colors to enhance the aesthetic appeal of the fixture. In addition, the tactile polymer may be transparent or translucent. In this embodiment the surface of the rigid support on which the polymer grip is disposed may be painted or otherwise tinted in a color that is complimentary to the color of the polymer, with fluorescent colors being preferred.

In a particularly preferred embodiment of the invention, at least one light source is included within a transparent or translucent grip substantially covering a rigid support. Again, substantially covered as used herein is meant that at least a major portion of the rigid support is covered. It is preferred that the entire support be covered. However, in some embodiments, a portion of the support may be exposed. The light source may be any light source, but is preferably a light emitting diode (LED). In combination with complimentary painting of the surface of the rigid support, the light source causes the entire transparent or translucent portion of the fixture to emit a soft glow. The light source provides a source of soft illumination, which serves the dual purpose of allowing an individual to locate a door in a darkened area and enhancing the aesthetic appeal of the fixture. In a preferred embodiment, the light source is a light emitting diode, more preferably a programmable light emitting diode capable of emitting at least two different colors. Where two or more LEDs of different colors, or one or more programmable LEDs are provided, the color emitted can be varied over time. Examples of different colors of LEDs that can be combined include green, blue, red and white. It should be clear that various combinations of these and other colors are possible and are within the scope of the invention.

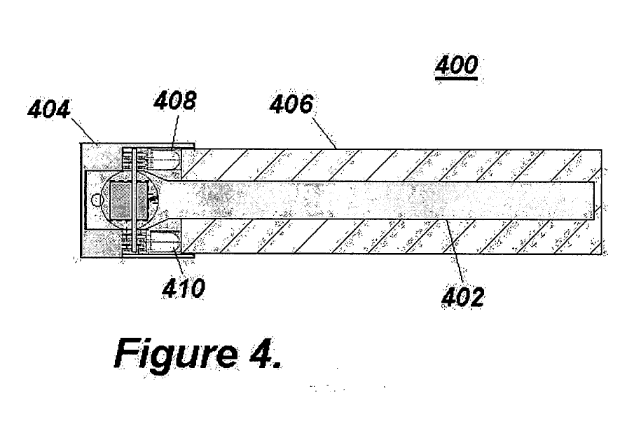

Referring to FIG. 4, an exemplary embodiment of a lever 400 incorporating light sources 408 and 410 is illustrated. Again, the fixture comprises a rigid support 402 incorporated into a latch assembly 404 for a doorway. The rigid support 402 is substantially covered by a grip 406, which is either transparent or translucent, and may be either rigid or pliant. In the case of a rigid grip, the grip may comprise any transparent or translucent material, including, but not limited to glass or a rigid polymer. In the exemplary embodiment illustrated, the light sources 408 and 410 are incorporated into the latch assembly 404.

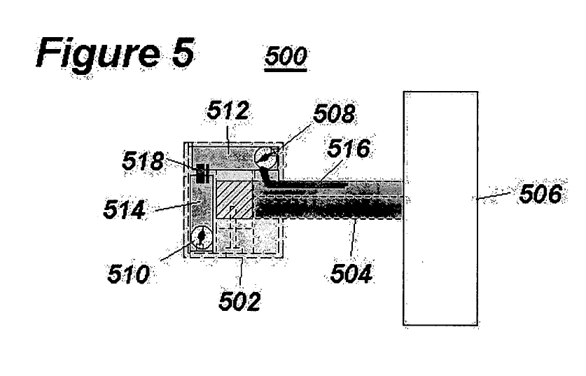

Referring to FIG. 5, another view of this embodiment is shown. Here the fixture 500 is shown with latch assembly 502 connected to door 506 by shaft 504. According to this embodiment, the light sources 508 and 510 are incorporated into cartridges 512 and 514, which can be inserted into assembly 502. Power to light sources 508 and 510 is supplied via wiring 516 and 518.

It should be noted that the embodiments illustrated thus far with reference to the figures all incorporate a rigid support for supporting a pliant polymer. It is envisioned that when a transparent or translucent rigid material is used to form the grip, that the rigid support will be unnecessary and is therefore optional. It should therefore be recognized that in such embodiments the fixture according to the current invention may comprise the grip without the supporting member. In such as case, the light source would be incorporated directly into the grip.

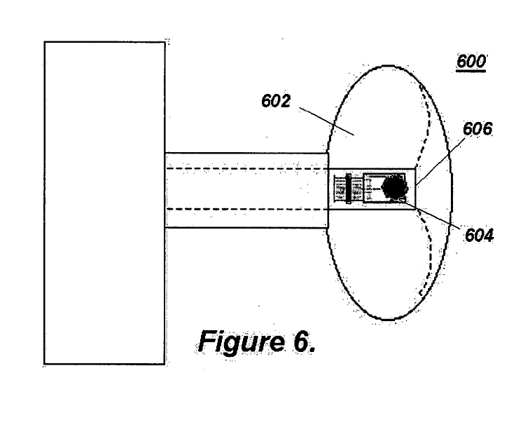

Referring to FIG. 6, an embodiment is shown an exemplary embodiment of a knob 600 according to the current invention. In this case the light source 604 is incorporated into the grip 602, which has only a single opening therein 606 for transmitting light.

Alternatively, the grip may comprise an opaque material, such as metal, wood, polymer or other composite having a plurality of perforations therein for transmitting light. In this embodiment the grip is hollow and light from the light sources is transmitted through the perforations, causing the fixture to glow. Again, in this embodiment the rigid support although optional is not necessary.

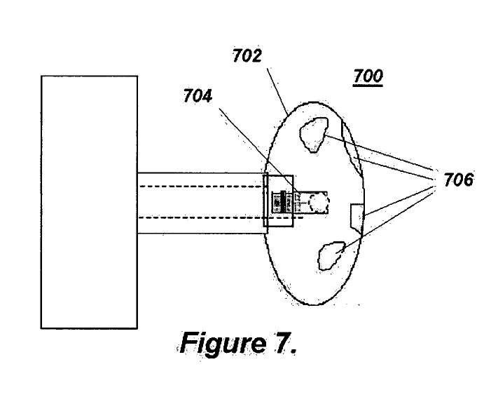

Referring to FIG. 7 this alternative embodiment of a knob 700 according to the current invention is shown. In this case, the rigid grip 702 is hollow and has light source 704 incorporated therein. The grip 704 has a plurality of perforations 706 on its surface for transmitting light to thereby illuminate the fixture.

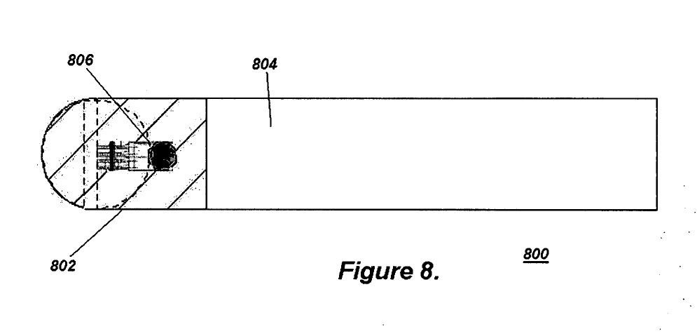

Referring to FIG. 8, an embodiment is shown an exemplary embodiment of a transparent or translucent lever 800 without the rigid support. In this case the light source 806 is incorporated into the a metal portion of the lever 802, which serves to connect the lever to the mechanical elements of a door latch, or directly to a door. In this case the translucent or transparent portion 804 of the lever is rigid and does not require a rigid support to be embedded in it.

According to another embodiment of the current invention, a fixture comprises a standard door latch assembly with a rigid support, on which may be a knob, handle or lever, with a translucent or transparent grip with at least one programmable light source incorporated therein. The light source may be any light source, but is preferably a light emitting diode (LED). The grip may comprise either a rigid material, such as glass, acrylic, polyketone, polycarbonate and polyimides, or it may be a pliant polymer, such as polyurethane. Again, alternatively, the grip may comprise an opaque material having a plurality of perforations therein for transmitting light. In this embodiment, light from the light sources is transmitted through the perforations, causing the fixture to glow. As previously discussed, where the grip comprises a rigid material, the rigid support is not necessary, and is therefore optional. According to this embodiment, the light source, or light sources, is capable of producing at least two different colors. In the case of two or more light sources, the light sources may be of different colors and light alternately or simultaneously, thereby conveying information about the status of a room connected to a doorway or to elicit a particular behavior from an individual. Examples of different colors of LEDs that can be combined include green, blue, red and white. Again, it should be clear that various combinations of these and other colors are possible and are within the scope of the invention. In the preferred embodiment, the light source is at least one programmable light emitting diode, which is capable of producing at least two different colors.

For example, a fixture according to this embodiment of the invention may be the door handle for a public bathroom. In this case, the fixture may have a green light and a red light, or preferably one or more programmable LEDs capable of producing both red and green light, disposed underneath or within the transparent or translucent grip. The light or lights are configured such that when the door of the bathroom is locked, a red light will be emitted causing the entire handle to glow red, indicating that the bathroom is occupied. When the door is unlocked a green light will be emitted causing the handle to glow green, indicating that the bathroom is unoccupied.

According to another example, the same combination can be used to convey a welcome, where the green light conveys the message, “Please Enter” and the red light conveys the message “Do Not Disturb.” Alternatively, red could be used to convey “Silence Please”, whereas green would mean “You May Speak.” This embodiment would have application where it is useful to have information conveyed that is not dependent on a particular language. In these and other embodiments where the change in emitted color is not triggered by an action, such as locking a door, the change may be actuated by other means a switch located on the door, or at a remote location.

In an alternative embodiment, where the at least two light sources are programmable light emitting diodes (LEDs), they may light simultaneously and thereby produce at least one additional color, which may be varied by varying the intensity with which the LEDs are lit. p In a further preferred embodiment, a grip may incorporate three light sources of different colors, for example red, green and blue. By varying the intensity of the lighting of the three light sources a multitude of further colors may be produced. This embodiment may be incorporated into a rigid or pliant translucent or transparent grip, or into an opaque grip having a plurality of perforations therein.

The application of the current invention beyond those examples described herein will be apparent to those having ordinary skill in the art. The examples are therefore not intended to be limiting. The full scope of the current invention will be defined by the claims appended hereto.

I claim:

1. A tactile fixture for a compartment or door, said tactile fixture comprising:
a knob, handle or lever comprising a rigid support and a pliant polymer grip,
said pliant polymer being deformable, such that when said knob, handle or lever is gripped by a user, said pliant polymer deforms in response, and
when released said polymer relaxes substantially to its original shape.

2. The tactile fixture according to claim 1, wherein said pliant polymer is a polyurethane.

3. The tactile fixture according to claim 2, wherein said polyurethane is a polyether/polyol.

4. The tactile fixture according to claim 1, wherein said pliant polymer is translucent or transparent

5. The tactile fixture according to claim 1, wherein said pliant polymer is opaque

6. The tactile fixture according to claim 4, wherein
said knob, handle or lever incorporates at least one light source therein.

7. The tactile fixture according to claim 6, wherein said rigid support is a color that is complimentary to a color of said pliant polymer.

8. The tactile fixture according to claim 6, wherein said at least one light source is a light emitting diode.

9. The tactile fixture according to claim 8, wherein said light emitting diode is a programmable light emitting diode capable of emitting at least two different colors of light.

10. The tactile fixture according to claim 9, wherein said knob, handle or lever is incorporated into a door latch assembly for a doorway, and said programmable light emitting diode alternately emits at least two different colors, thereby conveying information regarding the status of a room connected to said doorway.

11. A fixture for a door, comprising:
a translucent or transparent grip in the form of a knob, handle or lever,
said knob, handle or lever being incorporated into a door latch assembly for a doorway,
said knob, handle or lever incorporating at least one light source therein, whereby
said knob, handle or lever can be illuminated in at least two colors alternately.

12. The fixture according to claim 11, wherein, by illuminating said knob, handle or lever in at least two different colors alternately information is conveyed regarding the status of a room connected to said doorway.

13. The fixture according to claim 11, wherein said light source is at least one programmable light emitting diode capable of producing at least two colors.

14. The fixture according to claim 11, wherein said knob, handle or lever incorporates at least three light emitting diodes, which combining to each other will create a multicolor light.

15. The fixture according to claim 11, wherein a first and second light emitting diode are incorporated into said knob, handle or lever and light simultaneously to produce at least one third color.

16. The fixture according to claim 12, wherein said information is intended to produce a specific behavior by an individual.

17. The fixture according to claim 11, wherein said transparent or translucent grip comprises glass.

18. The fixture according to claim 1 1, wherein said transparent or translucent grip comprises a polymer.

19. The fixture according to claim 18, wherein said polymer is a rigid polymer.

20. The fixture according to claim 19, wherein, said rigid polymer is selected from the group consisting of: acrylic, polyketones, polyimides and polycarbonates.

21. The fixture according to claim 18, wherein said polymer is a pliant polymer, such that when said knob, handle or lever is gripped by a user, said pliant polymer deforms in response, and when released said polymer relaxes substantially to its original shape, said fixture further comprising a rigid support for said pliant polymer.

22. The fixture according to claim 21, wherein said pliant polymer is a polyurethane.

23. The tactile fixture according to claim 22, wherein said polyurethane is a polyether/polyol.

24. A fixture for a door or compartment, comprising:
a grip in the form of a knob, handle or lever,
said grip comprising a rigid shell having a plurality of perforations therein for transmitting light,
said knob, handle or lever incorporating at least one light source within said rigid shell, such that when said light source is activated light is transmitted through said plurality of perforations, whereby said knob, handle or lever is illuminated.

25. The fixture according to claim 24, wherein
said knob, lever or handle can be illuminated in at least two colors alternately, and thereby convey information regarding the status of a room connected to said doorway.

26. The fixture according to claim 25, wherein said at least one light source is a light emitting diode.

27. The fixture according to claim 26, wherein said light emitting diode is a programmable light emitting diode capable of emitting at least two different colors of light.

28. The fixture according to claim 25, wherein said knob, handle or lever incorporates at least two light emitting diodes, and a first light emitting diode emits a first color and a second light emitting diode emits a second color alternately.

29. The fixture according to claim 24, wherein said knob, handle or lever incorporates at least three light emitting diodes, which combining to each other will create a multicolor light.

30. A method for conveying information about the status of a room, the method comprising:
providing a door having a fixture thereon comprising:
a grip in the shape of a knob, handle or lever,
said grip being capable of transmitting light,
said fixture incorporating at least one light source therein, such that said fixture can be illuminated in at least two colors alternately,
programming said at least one light source so that the illuminated color of said fixture changes in response to the status of a room connected to said door.

31. The method according to claim 30, wherein said at least one light source is a programmable light emitting diode capable of emitting at least two colors, and the color emitted by said programmable light emitting diode changes in response to a change in the status of said room.

32. The method according to claim 30, wherein said fixture incorporates a first light source of a first color and a second light source of a second color and said first and second light sources light alternately in response to changes in the status of said room.

33. The method according to claim 30, wherein said grip comprises a rigid shell having a plurality of perforations therein for transmitting light.

34. The method according to claim 30, wherein said grip comprises a transparent or translucent material.

35. The method according to claim 34, wherein said transparent or translucent material is glass.

36. The method according to claim 34, wherein said transparent or translucent material is a polymer.
